(19) United States
(12) Patent Application Publication
(10) Pub. No.: US 2017/0249248 A1
(43) Pub. Date: Aug. 31, 2017

(54) DATA BACKUP

(71) Applicant: HEWLETT PACKARD ENTERPRISE DEVELOPMENT LP, Houston, TX (US)

(72) Inventors: Vincent NGUYEN, Houston, TX (US); David F. HEINRICH, Houston, TX (US); Han WANG, Houston, TX (US); Patrick A. RAYMOND, Houston, TX (US); Raghavan V. VENUGOPAL, Houston, TX (US); Barry L. OLAWSKY, Houston, TX (US)

(73) Assignee: HEWLETT PACKARD ENTERPRISE DEVELOPMENT LP, Houston, TX (US)

(21) Appl. No.: 15/500,087

(22) PCT Filed: Nov. 12, 2014
(86) PCT No.: PCT/US2014/065235

§ 371 Date: Jan. 30, 2017

(51) Int. Cl. G06F 12/0804; G06F 13/42; G06F 1/32; G06F 3/06

(52) U.S. Cl. CPC G06F 12/0804; G06F 3/0619; G06F 3/0647; G06F 3/0685; G06F 3/0625; G06F 13/4282; G06F 1/3287; G06F 2212/1032; G06F 2213/0026

(57) ABSTRACT

Example implementations relate to data backup. For example, a data backup can include tracking a location of a data block on a first node and initiating a transfer, utilizing a backup power supply, of the data block to a non-volatile memory location on a second node in response to an interruption of a primary power supply. In addition, the data block can be restored to the tracked location of the first node responsive to a restoration of the primary power supply.

### BACKGROUND

As reliance on computing systems continues to grow, so too does the demand for reliable power systems and backup schemes for these computing systems. Servers, for example, may provide architectures for backing up data to flash or persistent memory as well as backup power supplies for powering this backup after the interruption of a primary power supply.

### BRIEF DESCRIPTION OF THE DRAWINGS

FIG. 1 illustrates a diagram of an example of a system for data backup according to the present disclosure;

FIG. 2 illustrates a diagram of an example of a computing device according to the present disclosure;

FIG. 3 illustrates an example of an environment suitable for data backup according to the present disclosure;

FIG. 4 illustrates an example of a method for data backup according to the present disclosure; and

FIG. 5 illustrates an example of an environment suitable for data backup according to the present disclosure.

### DETAILED DESCRIPTION

A computing and/or data storage system can include a number of nodes. The nodes can be components of the computing and/or data storage system. For example, the nodes can include a server, a chassis of servers, a rack of servers, a group of racks of servers, etc. A node can support a plurality of loads. For example, a load can include cache memory, dual inline memory modules (DIMMs), Non-Volatile Dual In-Line Memory Modules (NVDIMMs), and/or array control logic, volatile memory and/or non-volatile memory, among other storage controllers and/or devices associated with the servers. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others.

A node can include a pool of, among other elements, volatile memory and/or non-volatile memory pooled from individual reservoirs of the same. That is, a node can include non-volatile memory that is physically located on separate devices and/or in separate locations, but the pool can be collectively treated as a single node. For example, a node can be a virtual node that can include a physical node, a local group of physical nodes, a globally distributed group of physical nodes, portions of other physical nodes, etc.

A computing and/or data storage system can have functions and or elements disaggregated across a number of nodes. For example, a first node can have volatile memory and can have little to no non-volatile memory while a second node can have volatile memory. Further, each of the plurality of nodes can be designated to perform a distinct process.

A computing and/or data storage system can include a backup power system operatively coupled to the number of nodes to support the number of loads in an event of an interruption of a primary power supply. The power system can include an error detection module that detects errors within a backup power and load discovery system, and a backup power controller module that determines a number of loads that are to be protected with backup power from the backup power supply, and configures the backup power supply to provide backup power to the loads.

An interruption of a primary power supply can be scheduled or un-scheduled. For instance, a scheduled interruption of the primary power supply can be the result of scheduled maintenance on the number of nodes and/or the number of loads. A scheduled interruption of the primary power supply can be an intentional power down of the number of nodes and/or the number of loads to add and/or remove nodes to a chassis and/or network connected to a primary power supply. In another example, a scheduled interruption of the primary power supply can be an intentional power down to add and/or remove one or more loads to or from one or more nodes.

An un-scheduled primary power supply interruption can be a failure (e.g., unintentional loss of power to the number of nodes and/or loads from the primary power supply, etc.) in the primary power supply. An un-scheduled primary power supply interruption can occur when, for example, the primary power supply fails momentarily and/or for an extended period of time.

It may be desirable to move data from cache memory in the number of nodes to non-volatile memory upon the interruption of a primary power supply. However, moving data from cache memory to non-volatile memory can involve a power supply. A backup power supply can be a secondary power supply that is used to provide power for transferring data from volatile cache memory to non-volatile memory when the primary power is interruption.

Providing backup power for transferring data from volatile memory to non-volatile memory may include providing each node involved in the transfer with a separate portion of a shared backup power supply, rather than providing a backup power supply for each node. That is, a single node containing a number of loads can be connected to a single shared backup power supply. In contrast, other backup power supply solutions may provide a dedicated backup power supply for each node, and therefore a single rack and/or chassis could contain a plurality of backup power supplies.

When the shared backup power supply is directly attached to each of the number of nodes, each of the number of nodes may be able to determine the state of the shared backup power supply. The state of the shared backup power supply can refer to the charge level of the shared backup power supply, the presence of the shared backup power supply itself, and/or the presence of charging errors in the shared backup power supply. With a shared backup power supply, the number of nodes may only see the output from the shared backup power supply after the shared backup power supply has charged and enabled its output to the number of nodes (e.g., the backup power supply is providing power to the number of nodes). In some examples, the number of nodes may not be able to ascertain whether the shared backup power supply is installed (e.g., present) and/or if it is off-line and charging. In other examples, the number of nodes may be able to ascertain whether the shared backup power supply is installed and/or if it is off-line and charging.

In accordance with examples of the present disclosure, backup power and load discovery can allow a backup manager to determine the state of the shared backup power supply before the shared backup power supply enables its output. In addition, backup power and load discovery can allow the backup manager to compare the true state of the shared backup power supply with the state of the shared backup power supply, and determine if a discrepancy exists. As used herein, the true state of the shared backup power supply is the state of the shared backup power supply, as determined by the shared backup power supply itself. Determining if a discrepancy in the state of the shared backup power supply exists allows for the detection of cabling errors (e.g., an error in a connection between a load and the shared backup power supply) between a load and the shared backup power supply. Further, determining if a discrepancy in the state of the shared backup power supply exists allows the node and/or a load within the node to receive out-of-band notifications about the shared backup power supply such as failure information.

In further accordance with examples of the present disclosure, a location of data within a plurality of nodes can be tracked and the backup power supply can be utilized to power portions of a plurality of nodes to accomplish a transfer of that data from a first node of the plurality of nodes to a non-volatile memory location on a second node of the plurality of nodes upon interruption of the primary power supply. Upon restoration of the primary power supply, the data can be restored to its tracked location on the first node.

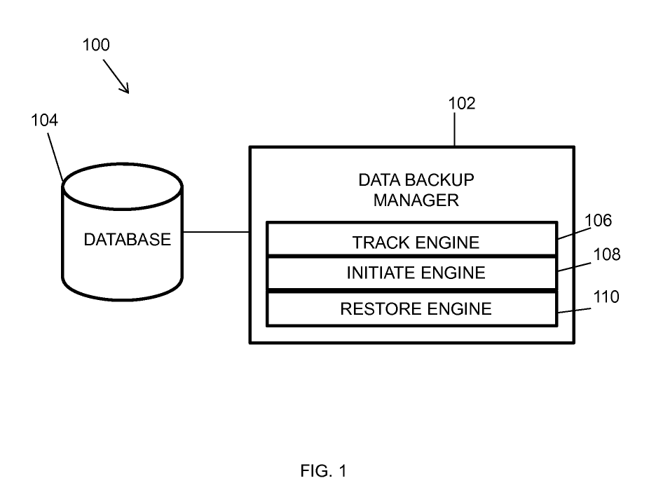

FIG. 1 illustrates a diagram of an example of a system 100 for data backup according to the present disclosure. The system 100 can include a database 104, a data backup manager 102, and/or a number of engines (e.g., tracking engine 106, initiate engine 108, restore engine 110). The backup manager 102 can be in communication with the database 104 via a communication link, and can include the number of engines (e.g., track engine 106, initiate engine 108, restore engine 110). The backup manager 102 can include additional or fewer engines than are illustrated to perform the various functions as will be described in further detail.

The number of engines (e.g., track engine 106, initiate engine 108, restore engine 110) can include a combination of hardware and programming, but at least hardware, that is to perform functions described herein (e.g., tracking a location of a data block on a first node, etc.). The programming can include program instructions (e.g., software, firmware, etc.) stored in a memory resource (e.g., computer readable medium, machine readable medium, etc.) as well as hard-wired programs (e.g., logic).

The track engine 106 can include hardware and/or a combination of hardware and programming, but at least hardware, to track a location of a data block (e.g., a physical record of data made up of a sequence of bytes and/or bits having a maximum length) on a first node. Tracking a location of a data block can include tracking the node within which the data block currently resides. For example, tracking the location of a data block can include identifying, tracking, and/or recording a current memory (e.g., volatile memory) location of a data block within a particular node of a plurality of nodes.

The initiate engine 108 can include hardware and/or a combination of hardware and programming, but at least hardware, to initiate a transfer, utilizing a backup power supply, of the tracked data block to a non-volatile memory location on a second node in response to an interruption of a primary power supply. The primary power supply of a plurality of nodes can be a shared primary power supply of the plurality of nodes and/or individual primary power supplies for each node. A primary power supply can be a supply of electric energy that is the primary source of energy for a node. The primary power supply can be the regular power supply for a node and/or for a plurality of nodes. For example, the primary power supply can include a utility provided power supply and/or main power panels.

An interruption of the primary power supply can initiate the supply of a backup power supply (e.g., an uninterruptible power supply (UPS), a micro-UPS (a secondary power supply that is used to provide emergency power to a load when a primary power supply (e.g., input power supply) is interrupted), a shared backup power supply directly attached to each of the number of nodes, etc.) to the nodes previously supplied by the primary power supply. A backup power supply can detect that the primary power supply has been interrupted and instigate provision of power to the node from the backup power supply. The backup power supply can be a single backup power supply shared among the nodes, can be a backup power supply for the node, and/or can be multiple back up power supplies running in parallel.

A data transfer can be initiated responsive to an interruption of the primary power supply. The data transfer can include a transfer of a data block from a first node to a second node. The first and second nodes can be separate nodes that are connected via a backup transfer channel. The first and second nodes can be physical nodes and/or virtual nodes. For example, the second node can be a virtual node that is distributed across locations (e.g., racks, chassis, data centers, facilities, geographies, etc.). The backup transfer channel, as used herein, can include a communication channel between nodes. The backup transfer channel can be a fabric, an Ethernet, and/or a peripheral component interconnect (PCI) express connection, etc. The data transfer can include transferring the data block from a first node (e.g., from a tracked volatile memory location of the first node) to a non-volatile memory location on a second node. The transfer can include encrypting the data block, in some examples. Additionally, the transfer can include compressing data blocks (e.g., encoding the data using fewer bits than the original representation). For example, data compression can be utilized to reduce non-volatile memory capacity usage on the second node for structured nonrandom data.

The restore engine 110 can include hardware and/or a combination of hardware and programming, but at least hardware, to restore the transferred data block to its corresponding tracked location of the first node. The restoration can occur in response to a restoration of the primary power supply.

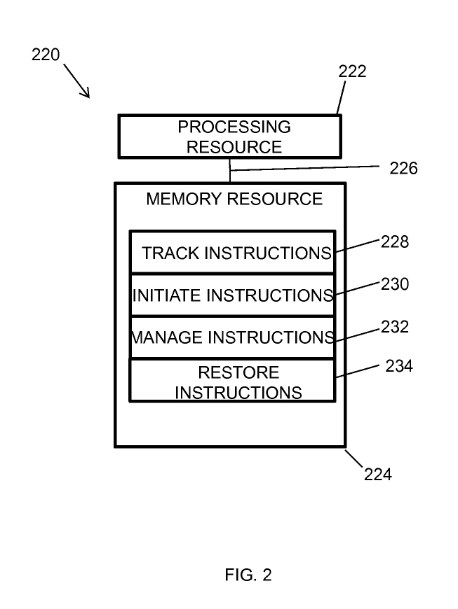

FIG. 2 illustrates a diagram of a computing device 220 according to the present disclosure. The computing device 220 can utilize software, hardware, firmware, and/or logic to perform functions described herein. The computing device 220 can be any combination of hardware and program instructions to share information. The hardware, for example, can include a processing resource 222 and/or a memory resource 224 (e.g., non-transitory computer-readable medium (CRM), machine readable medium (MRM), database, etc.). A processing resource 222, as used herein, can include any number of processors capable of executing instructions stored by a memory resource 224. Processing resource 222 can be implemented in a single device or distributed across multiple devices. The program instructions (e.g., computer readable instructions (CRI)) can include instructions stored on the memory resource 224 and executable by the processing resource 222 to implement a desired function (e.g., track a location of a data block on a first node; initiate a transfer, utilizing a backup power supply, of the data block from the first node to a non-volatile memory location on a second node in response to a loss of a primary power supply; manage a shutdown of the first node after the transfer; restore the data block to the tracked location of the first node from the non-volatile memory location on the second node; etc.).

The memory resource 224 can be in communication with the processing resource 222 via a communication link (e.g., a path) 226. The communication link 226 can be local or remote to a machine (e.g., a computing device) associated with the processing resource 222. Examples of a local communication link 226 can include an electronic bus internal to a machine (e.g., a computing device) where the memory resource 224 is one of volatile, non-volatile, fixed, and/or removable storage medium in communication with the processing resource 222 via the electronic bus.

A number of instructions (e.g., track instructions 228; initiate instructions 230; manage instructions 232; restore instructions 234) can include CRI that when executed by the processing resource 222 can perform functions. The number of instructions can be sub-instructions of other instructions. For example, the manage instructions 232 and the restore instructions 234 can be sub-instructions and/or contained within the same computing device. In another example, the number of instructions can comprise individual instructions at separate and distinct locations (e.g., CRM, etc.).

Each of the number of instructions can include instructions that when executed by the processing resource 222 can function as a corresponding engine as described herein. For example, the track instructions 228 can include instructions that when executed by the processing resource 222 can function as the track engine 106. In another example, the initiate instructions 230 and manage instructions 232 can include instructions that when executed by the processing resource 222 can function as the initiate engine 108. In another example, the restore instructions 234 can include instructions that when executed by the processing resource 222 can function as the restore engine 110.

The track instructions 228 can be executed by the processing resource 222 to cause the computing device 220 to track a location of a data block on a first node. The initiate instructions 230 can be executed by the processing resource 222 to initiate a transfer, utilizing a backup power supply, of the data block from the first node to a non-volatile memory location on a second node in response to a loss of a primary power supply. The backup power supply can be a backup power supply pool, which can provide power redundancy (e.g., backup power supplies to backup power supplies) and flexibility (e.g., different power supplies that can be dynamically selected to suit different loads, etc.). The manage instructions 232 can be executed by the processing resource 222 to cause the computing device 220 to manage a shutdown of the first node after the transfer. The restore instructions 234 can be executed by the processing resource 222 to cause the computing device 220 to restore the data block to the tracked location of the first node from the non-volatile memory location on the second node.

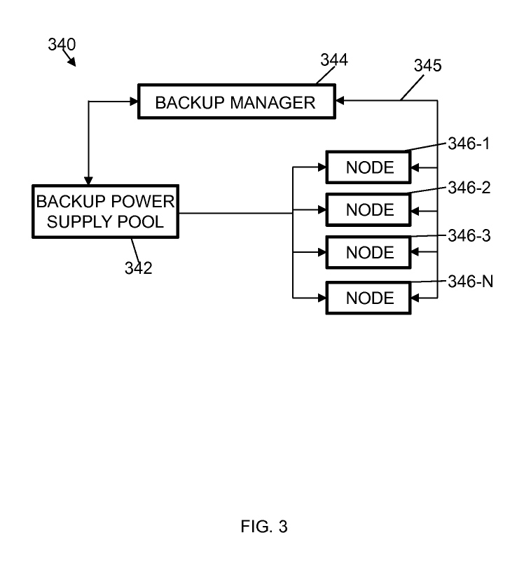

FIG. 3 illustrates an environment 340 for data backup according to the present disclosure. The environment 340 can include software and/or hardware to function as the number of engines (e.g., track engine 106, initiate engine 108, restore engine 110) of FIG. 1 and/or the number of instructions (e.g., track instructions 228; initiate instructions 230; manage instructions 232; restore instructions 234) of FIG. 2. The environment 340 can be a portion of a computing device and/or data storage system.

The environment 340 can include a backup power supply pool 342, a backup manager 344, backup transfer channel 345, and a plurality of nodes 346-1 . . . 346-N. The backup power supply pool 342 can be a separate power supply that is used to provide power for a node (e.g., if there are two nodes then each node can be coupled to a separate backup power supply). Alternatively, the backup power supply pool 342 can be a shared power supply that is external to a node (e.g., 346-1) and external to a chassis/host controller (not shown) supporting the node. The backup power supply pool 342 can provide power to the node (e.g., power the loads of the node). The backup power supply pool 342 can support different chassis/host controllers (not shown) and different MUXs (not shown) to support a plurality of nodes on different chassis, in some examples.

The plurality of nodes 346-1 . . . 346-N can be individual server nodes, individual server nodes of a chassis, individual servers on a rack, groups of server racks, pooled server resources (e.g., non-volatile memory, etc.) classified as a node, etc. The plurality of nodes 346-1 . . . 346-N can collectively be a computing and/or data storage system (e.g., a client-server architecture).

The plurality of nodes 346-1 . . . 346-N can be virtual nodes. In some examples, the nodes 346-1 . . . 346-N and/or a subset of the node 346-1 . . . 346-N can be located in different geographical locations and/or rooms of a datacenter. For example, a first node 346-1 can include a first rack located in city A and the second node 346-2 can include a second rack located in city B. That is, the environment 340, in some examples, can include a distributed datacenter. A distributed datacenter can include a plurality of nodes located in multiple locations.

Each node 346-1 . . . 346-N can include can include a main logic board (MLB) (not shown), and the MLB can include system firmware (not shown). System firmware can be computer executable instructions stored on the node. Examples of system firmware can include Basic Input/Output System (BIOS), and a Baseboard Management Controller (BMC) unit. BIOS can provide initialization and testing of the hardware components of the node, loads, and an operating system for the node when it is powered on. The BMC unit can be a specialized microcontroller, system on a chip (SoC), etc., embedded on the motherboard of a node, and that manages the interface between system management software and platform hardware. For example, different types of sensors built into the node can report to the BMC unit on parameters such as temperature, cooling fan speeds, power status, and operating system status, among other parameters. While examples herein include BIOS and a BMC unit as examples of system firmware, examples of the present disclosure are not so limited. Other types of system firmware can be used to perform the various examples described in this disclosure. Actions described as being performed by BIOS can be performed by a BMC unit and/or other types of system firmware. Similarly, actions described as being performed by a BMC unit can be performed by BIOS and/or other types of system firmware.

Each node 346-1 . . . 346-N, in addition to the described hardware and software, can include a variety of other resources. For example, a node can include a processor, non-volatile memory, volatile memory, etc. Each node 346-1 . . . 346-N can include disparate resources (e.g., a first node (e.g., 346-1) can, for example, have a small quantity and/or no non-volatile memory while a second node (e.g., 346-3) can, for example, have non-volatile memory). That is, the collective resources of a computing and/or data storage system can be disaggregated and separated into distinct nodes.

Non-volatile memory can be costly as compared to volatile memory and/or other resources. Therefore, costs can be reduced by providing a single or relatively smaller pool of nodes including non-volatile memory. A single non-volatile memory node can allow persistent data in a computing and/or data storage system made up of a plurality of nodes 346-1 . . . 346-N without incorporating the costly non-volatile memory into every node and/or every load of every node of the plurality of nodes 346-1 . . . 346-N. Such an arrangement can provide persistent data in runtime applications on nodes that do not themselves contain costly non-volatile memory. Non-volatile memory can be allocated to an application memory space across the plurality of nodes 346-1 . . . 346-N.

The non-volatile memory included in a node can have a size (e.g., a storage capacity) and a physical location (e.g., the physical non-volatile memory storage resource). The non-volatile memory size and location can be continuously and/or periodically changed to accommodate the current specifications of a computing and/or data storage system (e.g., the amount of data in volatile memory locations across the plurality of nodes 346-1 . . . 346-N, etc.), for example.

Each node can host a number of loads. For example, a load can include the volatile (e.g., cache) and/or non-volatile (e.g., non-volatile memory dual inline memory modules (NVDIMM)) memory, array control logic, storage controllers, etc. A node can include some or all of these example loads.

The BMC unit can communicate from BIOS to the backup power supply pool 342, a subset of the loads on the plurality of nodes 346-1 . . . 346-N that are to be protected by the backup power supply pool 342. In some examples, more than one subset of loads can be identified for protection by the backup power supply pool 342. The loads can be identified by, for example, sequentially powering the plurality of loads of a node with the backup power supply pool 342, during which the BIOS can determine associated load connections to the plurality of nodes 346-1 . . . 346-N.

In another example, BIOS can determine an amount of time it will take for the backup power supply pool 342 to charge in order to provide backup power to the loads or a subset of the loads, and can communicate the determined amount of time to the loads and/or the subset of the loads.

During startup of a node, system firmware (e.g., such as BIOS or BMC unit) within the nodes 346-1 . . . 346-N can communicate with all loads to determine how many (e.g., a subset) of the loads are to be protected with backup power from the backup power supply pool 342. Once the BIOS determines the number of loads that are to be protected with backup power, the BIOS can communicate the determined number to the backup manager 344 and/or the backup power supply pool 342, through another component of the system firmware, such as a BMC unit. In response to receiving the determined number of loads that are to be protected with backup power, the BMC unit can configure the backup power supply pool 342 with the correct number of loads. Similarly, the backup manager 344 and/or the backup power supply pool 342 can determine the charge level that will be used in order to provide backup power to the loads and/or a subset of the loads in the plurality of node 346-1 . . . 346-N.

In some examples, the system firmware can determine the state of the backup power supply pool 342 and determine how long the backup power supply pool 342 will have to charge before it can turn on and send an output signal to the loads. In other words, the system firmware can determine a current charge level of the backup power supply pool 342, and determine based on the current charge level, how long the backup power supply pool 342 will have to charge before it can provide backup power to the loads. The loads can be unaware of the existence of the backup power supply pool 342 until the backup power supply pool 342 sends an output to the loads and/or a subset of the loads.

In response to determining the state of the backup power supply pool 342 and the charge time necessary to adequately charge the backup power supply pool 342 to provide backup power to the plurality of loads, the system firmware can communicate information back to the plurality of loads. For example, the system firmware can communicate the state of the shared backup power supply to the plurality of loads in the plurality of nodes 346-1 . . . 346-N. In another example, the system firmware can communicate to the plurality of loads, the duration of time until the backup power supply pool 342 is adequately charged (e.g., fully charged). As used herein, an adequate charge of the backup power supply pool 342 refers to a level of power stored in the backup power supply pool 342 that is capable of providing backup power supply to a specified number of loads long enough to complete a transfer of a data block between the plurality of nodes 346-1 . . . 346-N.

The backup power supply pool 342 can include a number of cells coupled in parallel. As used herein, the cells are devices that provide backup power. For example, a cell can be a battery, among other backup power devices. Each of the cells can include a charger, a cell controller, and control logic module.

Providing backup power via cells coupled in parallel can increase the quantity of loads that are supported by the cells as compared to providing backup power via a single cell. Each backup power supply cell can include a charging module to charge an associated backup power supply cell. Each backup power supply cell can also include a cell controller to control the charging module and to communicate with a management module. A parallel backup power supply can also include the management module configured to activate each of the plurality of backup power supply cells in parallel as each of the plurality of backup power supply cells becomes fully charged

Providing backup power via cells coupled in parallel can also provide flexibility in adding and/or removing loads from the backup power system by adding and/or removing cells from the cells coupled in parallel without disrupting power services provided to the remaining loads.

Further, the backup power supply pool 342 can include multiple backup power supplies running in parallel. In this manner, if a primary backup power supply of the multiple backup power supplies fails, then another of the backup power supplies can substitute as the primary backup power supply. That is, multiple backup power supplies running in parallel can provide backup power supplies to the backup power supply.

The environment 340 can include a backup manager 344. The backup manager 344 can be computer executable instructions that manage a data backup according to examples of the present disclosure. The backup manager 344 can be stored (wholly or partially) on a node and/or on the backup power supply pool 342. In some examples, the system firmware of a node can include the backup manager 344. In some examples, the backup manager 344 can be stored on a server node of a chassis, a server of a rack of servers, and/or a server rack of a group of racks, while managing the transfer of data blocks between nodes and/or the powering of nodes of the plurality of nodes. The backup manager 344 can be stored on a first node (e.g., 346-1) from which the data block is being transferred, on a second node (e.g., 346-2) to which the data block is being transferred, and/or on a separate third node (e.g., 346-N) from the first or second node. The backup manager 344 can be a datacenter level application that manages data backup among a plurality of nodes. Alternatively the backup manager 344 can be stored remotely from the plurality of nodes 346-1 . . . 346-N.

The backup manager 344 can track data (e.g., a data block) stored on a node. Tracking data blocks can include tracking a node on which the data block currently resides. Tracking data blocks can include tracking a memory location on the node where the data block currently resides. For example, tracking can include determining, updating, and/or recording the location of a data block on a first node of the plurality of nodes. The location of the data block can be a volatile memory address on the volatile memory of the first node where the data is currently stored.

In some examples, tracking data can also include tracking a tenant with which the data is associated in a multi-tenant computing and/or data storage system. For example, data can be stored on the plurality of nodes 346-1 . . . 346-N for a plurality of tenants (e.g., customers/entities) as a service.

The backup manager 344 can monitor the plurality of nodes and the corresponding backup power supply pool 342. Monitoring can include determining the loads of each node of the plurality of nodes 346-1 . . . 346-N. For example, monitoring can include determining the loads of a first node that has tracked data blocks stored in its volatile memory. The loads can be loads of the entire node and/or the loads of a portion of the node (e.g., a portion of the node involved in the transfer of the tracked data block from the first node to a second node). Monitoring can additionally include determining the loads of a second node having non-volatile memory to which the tracked data block is to be transferred in the event of an interruption of the primary power supply. The loads can be loads of the entire second node and/or the loads of a portion of the second node (e.g., a portion of the node involved in the transfer and writing of the tracked data block to the non-volatile memory).

Monitoring can further include determining cumulative loads of portions of the plurality of nodes 346-1 . . . 346-N. The determined loads can be used in determining if a backup power supply pool 342 has adequate power to support a transfer function and to determine which, if any, transfer functions to execute.

In some examples, monitoring can include determining an amount of time that a backup power supply pool 342 will need to supply power to the determined loads to permit the completion of the transfer and/or writing of the tracked data block from the volatile memory location of the first node to the non-volatile memory location of the second node. In an example including a plurality of first nodes having data blocks in their volatile memory to be transferred to non-volatile memory in a second node upon an interruption of a primary power supply, the second node can require a longer duration of power supply to its loads than the plurality of first nodes. Since the second node can be involved in the transfer and write of a data block from the volatile memory locations of all the plurality of first nodes to its non-volatile memory location, it can remain powered through the duration of the transfer from each of the plurality of nodes 346-1 . . . 346-N and through the write process of the data.

For example, if there are ten nodes (first nodes) with data blocks in their respective volatile memories that will be transferred to the non-volatile memory of a single node (second node) and each transfer and/or write occurs over one hundred fifty seconds, then the loads of the ten first nodes can be respectively powered for one hundred fifty seconds while the second node can be powered for one thousand five hundred seconds to complete the transfer and/or write from each of the plurality of the ten first nodes.

A total backup power supply to complete a transfer and/or write during a primary power supply interruption can be determined based on an amount of power that can power the determined loads for the determined duration and to write the data block to the second node. A backup power supply pool 342 can be a finite supply of power. The backup manager 344 can determine if the backup power supply pool 342 can support (e.g., supply adequate power to the loads) the loads long enough to complete the transfer and/or write the data block for the plurality of nodes 346-1 . . . 346-N by comparing the capacity and/or current charge level of the backup power supply pool 342 with the total backup power supply determined as adequate to complete the transfer and/or write.

Monitoring the backup power supply pool 342 can include determining the characteristics of the backup power supply pool 342. For example, monitoring can include determining a capacity of the backup power supply pool 342 and a present charge level of the backup power supply pool 342. Monitoring can further include monitoring the use of the backup power supply pool 342. For example, monitoring can include determining whether the backup power supply pool 342 is supplying power to the plurality of nodes 346-1 . . . 346-N. In an example, the backup power supply pool 342 can determine whether the primary power supply has been interrupted by determining that the backup power supply pool 342 is supplying power to the loads of the plurality of nodes 346-1 . . . 346-N.

In an example, monitoring the plurality of nodes 346-1 . . . 346-N can include monitoring loads associated with a tracked volatile memory location on a first node and the loads utilized in the transfer of the data block from the tracked volatile memory location on the first node to the non-volatile memory on a second node. Monitoring the loads can include determining an amount of time over which the loads utilize backup power during a transfer and/or write the tracked data block from the first node to the non-volatile memory of a second node. That is, the backup manger 344 can determine the amount of power that a backup power supply pool 342 uses to support loads associated with the transfer of the data block from a first node to a second node long enough to complete that transfer. Such a determination can be based on the loads and the amount of time involved in completing a transfer of a data block from a volatile memory location of a first node to a non-volatile memory location of a second node as derived from node performance and/or node-specifications.

The backup manager 344 can initiate the transfer of a data block from at least a first node of the plurality of nodes 346-1 . . . 346-N to a non-volatile memory location on a second node of the plurality of nodes 346-1 . . . 346-N. The transfer can occur in response to detecting the interruption of the primary power supply of at least the first node of the plurality of nodes 346-1 . . . 346-N and/or the utilization of the backup power supply pool 342. The transfer and its initialization can utilize the backup power supply pool 342. Initiating the transfer can include transferring and/or copying tracked data blocks from the first node to a second node across a backup transfer 345 channel connecting the nodes. The backup transfer channel 345 can include a bi-directional data transfer link among the nodes 346-1 . . . 346-N and/or the backup manger 344. The backup transfer channel 345 can include an array of connections including local wired connections and/or complicated topological structures (e.g., complex networks, etc.) connecting geographically distributed nodes, etc.

The transfer can include the writing the data block to a non-volatile memory location of the second node. For example, initiating the transfer can include initiating a transfer and/or write of a data block from a volatile memory location of a server node in a server chassis to a non-volatile memory location of a separate second server node in the server chassis via a backup transfer channel 345 connecting the server nodes. In another example, initiating the transfer can include initiating a transfer and/or write of a data block from a volatile memory location of a server in a server rack to a non-volatile memory location in a separate second server in the server rack via a backup transfer channel 345 connecting the servers. In another example, initiating the transfer can include initiating a transfer and/or write of a data block from a volatile memory location of a server rack of a plurality of server racks to a non-volatile memory location in a separate second server rack of the plurality of server racks via a backup transfer channel 345 connecting the plurality of server racks.

Additionally, the transfer can include encrypting the data block being transferred. In this manner, the data block can remain secure while being transferred to, written on, stored in, and/or restored from the non-volatile memory of a separate second node. For instance, data blocks can be stored on the nodes 346-1 . . . 346-N for a multiple tenants, as discussed further herein. The data for a particular tenant can be tracked, transferred to a second node with non-volatile memory in the event of a primary power supply interruption, and encrypted to isolate the data for the particular tenant from data for other tenants.

The backup manager 344 can initiate the transfer of a data block based on the monitoring of the backup power supply pool 342 as described above. The backup manager 344 can determine whether a backup power supply pool 342 can support (e.g., supply adequate power to) the loads long enough to complete the transfer and/or write for the plurality of nodes 346-1 . . . 346-N. Based on this determination, the backup manager 344 can initiate the transfer of a data block if the backup power supply pool 342 contains an adequate amount of power to power the loads of the plurality of nodes 346-1 . . . 346-N long enough to complete the transfer and/or write for the plurality of nodes 346-1 . . . 346-N. If the backup manager 344 determines that the backup power supply 342 does not contain enough power to complete the transfer and/or write for the plurality of nodes 346-1 . . . 346-N then the backup manager cannot initiate the transfer of data.

Alternatively, where the backup power supply pool 342 does not contain enough power to complete the transfer and/or write for the plurality of nodes 346-1 . . . 346-N, the backup manager 344 can select a portion of the loads, a portion of the node 346-1 . . . 346-N s, and/or a portion of the data transfers to power (e.g., power less than all of the loads necessary to complete the transfer and/or write for the plurality of nodes 346-1 . . . 346-N). For example, the backup manager 344 can prioritize a plurality of data transfers involved in a complete transfer and/or write of tracked data blocks for the plurality of nodes 346-1 . . . 346-N and initiate only those transfers and/or writes for which the backup power supply pool 342 has adequate power to complete in order of prioritization.

The backup manager 344 can manage a shutdown of a node after the transfer is complete. Managing a shutdown can include monitoring (e.g., polling, receiving signals indicative of, etc.) the status of a transfer and/or write of a data block from a first node. Managing a shutdown can further include shutting down each node of the plurality of nodes 346-1 . . . 346-N upon completing the transfer of its respective data block. For example, managing a shutdown can include shutting down a first node (e.g., ceasing supply of power to the loads, initiating a sequenced shut down of the node, transitioning the node to a low power state, etc.) upon completion of the transfer and/or write of the data block from that node. In this manner, the backup manager 344 can conserve its finite backup power supply pool 342.

The backup manager 344 can conserve the backup power supply pool 342 by efficient use of the supply including ceasing power provision/power consumption to/by loads on nodes that have transferred their data. That is, instead of supporting all of the loads of all of the plurality of nodes 346-1 . . . 346-N until all of the tracked data blocks identified for transfer from all of the plurality of nodes 346-1 . . . 346-N is transferred and/or written to a non-volatile memory location of a second node, the backup power supply pool 342 can supply power to the loads of a given node to complete the transfer of data block from the volatile memory location of that particular node to the non-volatile memory of the second node. Thereafter, the backup manager 344 can cease supplying backup power (e.g., entirely or partially) to the loads of the given node and initiate a shutdown of the node.

The environment 340 can be a multi-tenant computing and/or data storage system. For example, individual nodes and/or groups of nodes can correspond to individual tenants in the multi-tenant computing and/or data storage system. Therefore, the data block stored in each of the nodes can be data of a particular tenant. The data from a plurality of tenants can be transferred to the non-volatile memory location of a single node or a portion of the plurality of nodes 346-1 . . . 346-N less than the number of tenants utilizing the multi-tenant computing and/or data storage system.

The data blocks whose transfer to the non-volatile memory location of a second node originates from a first node associated with a first tenant can be partitioned within the non-volatile memory of the second node from the data blocks whose transfer to the non-volatile memory location of the second node originates from a node associated with a second tenant. That is, data blocks transferred from separate nodes of the plurality of nodes 346-1 . . . 346-N and/or separate tenants can be partitioned from one another in the non-volatile memory of a second node. This can allow the data of different tenants to remain separated and/or isolated.

The backup manager 344 can restore the transferred and/or written data blocks from a non-volatile memory location of a second node to its originating node (e.g., first node). The restoration can be based on the tracked location of the data block with reference to the first node. That is, the backup manager 344 can restore the data block to its original node and/or memory location in the first node as tracked prior to the transfer.

The restoration can include transferring the earlier transferred data block from the non-volatile memory location of a second node back to a volatile memory location of the first node from which it originated. In some examples, restoring the data block can include decrypting the data block upon its transfer to the originating node. Restoring the data block can be initiated upon restoration of the primary power supply to the plurality of nodes 346-1 . . . 346-N. That is, the backup manger 344 can restore the transferred and/or written data block from a non-volatile memory location of a second node to its originating node (e.g., the first node) upon detecting that primary power has been restored to the second node, the first node, and/or the plurality of nodes 346-1 . . . 346-N.

A node of the plurality of nodes 346-1 . . . 346-N can be a primary non-volatile memory node (e.g., a second node). A primary non-volatile memory node can be a node which contains non-volatile memory and/or a pool of non-volatile memory. Data blocks transferred from a volatile memory location of a first node (e.g., a node separate from the primary non-volatile memory node that may have comparatively less or no non-volatile memory) to the second node can be transferred to, stored in, and/or restored from the non-volatile memory of the second node. Data storage virtualization and data redundancy schemes (e.g., redundant array of independent disks (RAID), etc.) can be employed with regard to the non-volatile memory of the second node.

A second node can include an abstraction of a destination node. That is, the second node can be a virtual node including a portion of resources from a first node (physical or virtual), a local group of physical nodes, globally distributed physical nodes, etc.

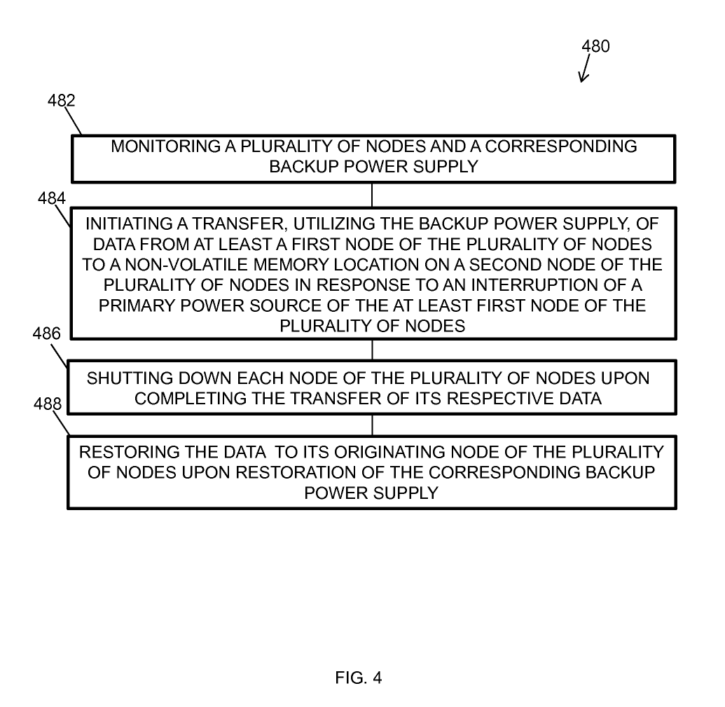

FIG. 4 illustrates a flow chart of an example of a method 480 for data backup according to the present disclosure. In some examples, the method 480 can be performed utilizing a system (e.g., system 100 as referenced in FIG. 1), a computing device (e.g., computing device 220 as referenced in FIG. 2), and/or an environment (e.g., environment 340 as referenced in FIG. 3).

At 482, the method 480 can include monitoring a plurality of nodes. Additionally, the method 480 can include monitoring a backup power supply corresponding to the plurality of nodes. A corresponding backup power supply can be a backup power supply that supplies power to the loads of the plurality of nodes in the event of an interruption of a primary power supply powering the plurality of nodes.

At 484, the method 480 can include initiating a transfer of data from at least a first node of the plurality of nodes to a non-volatile memory on a second node of the plurality of nodes. The transfer can be initiated and/or performed utilizing the backup power supply and/or a backup manager. That is, the backup power supply can power the loads of the plurality of nodes, a backup manager, and/or a backup transfer channel during initiation and execution of the data transfer. The transfer can be initiated in response to an interruption of a primary power supply of the at least first node of the plurality of nodes.

At 486, the method 480 can include shutting down each node of the plurality of nodes. Shutting down each node can be initiated and/or performed upon completion of the transfer of a respective node's data. That is, the method 480 can include shutting down each node of the plurality of nodes upon completing the transfer of its respective data.

At 488, the method 480 can include restoring the data stored in the non-volatile memory on the second node to its originating node of the plurality of nodes. The restoration of the data to an originating node can be based on restoration of the corresponding primary power supply. For example, once a primary power supply is restored, a restoration of the data can occur.

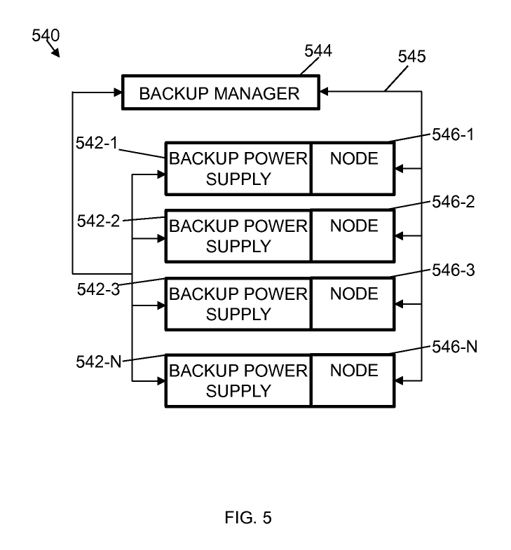

FIG. 5 illustrates an example of an environment 540 suitable for data backup according to the present disclosure. The environment 540 can include software and/or hardware to function as the number of engines (e.g., track engine 106, initiate engine 108, restore engine 110) of FIG. 1 and/or the number of instructions (e.g., track instructions 228; initiate instructions 230; manage instructions 232; restore instructions 234) of FIG. 2. The environment 540 can be a portion of a distributed computing device and/or data storage system.

The environment 540 can include a plurality of distributed backup power supplies 542-1 . . . 542-N, a backup manager 544, backup transfer channel 545, and a plurality of nodes 546-1 . . . 546-N. The plurality of distributed backup power supplies 542-1 . . . 542-N can be individual power supplies corresponding to each node of the plurality of nodes 546-1 . . . 546-N. That is, each of the plurality of distributed backup power supplies 542-1 . . . 542-N can be coupled to a separate corresponding node of the plurality of nodes 546-1 . . . 546-N to which it can supply backup power.

The plurality of nodes 546-1 . . . 546-N can be individual server nodes, individual server nodes of a chassis, individual servers on a rack, groups of server racks, pooled server resources (e.g., non-volatile memory, etc.) classified as a node, etc. The plurality of nodes 546-1 . . . 546-N can collectively be a computing and/or data storage system (e.g., a client-server architecture).

The plurality of nodes 546-1 . . . 546-N can be virtual nodes. In some examples, the nodes 546-1 . . . 546-N and/or a subset of the nodes 546-1 . . . 546-N can be located in different geographical locations. For example, a first node 546-1 can include a first rack located in city A and the second node 546-2 can include a second rack located in city B. That is, the environment 540, in some examples, can include a distributed datacenter. A distributed datacenter can include a plurality of nodes located in multiple locations.

The backup manager 544 can be computer executable instructions that manage a data backup according to examples of the present disclosure. The backup manager 544 can be stored (wholly or partially) on a node and/or on a backup power supply. In some examples, the system firmware of a node can include the backup manager 544. In some examples, the backup manager 544 can be stored on a server node of a chassis, a server of a rack of servers, and/or a server rack of a group of racks, while managing the transfer of data blocks between nodes and/or the powering of nodes of the plurality of nodes. The backup manager 544 can be stored on a first node (e.g., 546-1) from which the data block is being transferred, on a second node (e.g., 546-2) to which the data block is being transferred, and/or on a separate third node (e.g., 546-N) from the first or second node. The backup manager 544 can be a datacenter level application that manages data backup among the plurality of nodes 546-1 . . . 546-N. Alternatively the backup manager 544 can be stored remotely from the plurality of nodes 546-1 . . . 546-N.

The backup manager 544 can track a location of a data block on a first node (e.g., 546-1). Additionally, the backup manager 544 can initiate a transfer, utilizing a portion of the plurality of distributed backup power supplies 542-1 . . . 542-N, of the data block to a non-volatile memory location on a second node (e.g., 546-2) in response to an interruption of a primary power supply. For example, the backup manager 544 can initiate the transfer of a data block from a volatile memory location of the a first node (e.g., 546-1) to a non-volatile memory location of a second node (e.g., 546-2) utilizing the corresponding distributed backup power supplies (e.g., power supply 541-1 corresponding to first node 546-1 and power supply 541-2 corresponding to second node 546-2). In an additional example, the backup manager 544 can initiate the transfer of a data block from a volatile memory location of the a first node (e.g., 546-1) to a non-volatile memory location of a second node (e.g., 546-2) utilizing the plurality of distributed backup power supplies 542-1 . . . 542-N, each of the plurality of distributed backup power supplies 542-1 . . . 542-N powering a respective group of nodes. That is, the initiation and the transfer of the data block between a first node (e.g., 546-1) and a second node (e.g., 546-2) can be powered by not only power sourced from directly corresponding distributed backup power supplies (e.g., power supply 541-1 corresponding to first node 546-1 and power supply 541-2 corresponding to second node 546-2), but can be sourced from other power supplies of the plurality of distributed backup power supplies 542-1 . . . 542-N (e.g., first node 546-1 and/or second node 546-2 can be powered by power sourced from 542-3 and/or 542-N). In such an example, the power supply (e.g., 546-N) can be utilized to power a group of nodes (e.g., 546-1, 546-2, and 546-N). The transfer can occur over a backup transfer channel 545 providing a bi-direction data communication channel between the plurality of nodes 546-1 . . . 546-N. The backup transfer channel 545 can include a network providing bi-direction data communication among a plurality of geographically disparate nodes 546-1 . . . 546-N. The backup manager 544 can also restore a transferred data block to its originating tracked location of the first node (e.g., 546-1) responsive to a restoration of the primary power supply.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present disclosure, and should not be taken in a limiting sense.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed is:

1. A data backup system, comprising:
a track engine to track a location of a data block on a first node;
an initiate engine to initiate a transfer, utilizing a backup power supply, of the data block to a non-volatile memory location on a second node in response to an interruption of a primary power supply; and
a restore engine to restore the data block to the tracked location of the first node responsive to a restoration of the primary power supply.

2. The system of claim 1, wherein the backup power supply is a single backup power supply.

3. The system of claim 1, wherein the backup power supply is multiple backup power supplies running in parallel.

4. The system of claim 1, wherein the first node and the second node are connected via a backup transfer channel.

5. The system of claim 4, wherein the backup transfer channel is at least one of a fabric, an Ethernet, and a Peripheral Component Interconnect (PCI) Express connection.

6. The system of claim 4, wherein the initiate engine encrypts the data block.

7. A non-transitory machine readable medium storing instructions executable by a processing resource to cause a computing device to:
track a location of a data block on a first node;
initiate a transfer, utilizing a backup power supply, of the data block from the first node to a non-volatile memory location on a second node in response to an interruption of a primary power supply;
mange a shutdown of the first node after the transfer; and
restore the data block to the tracked location of the first node from a pool of non-volatile memory location on the second node.

8. The medium of claim 7, further comprising instructions executable by the processing resource to cause the computing device to determine whether the backup power supply can provide power to a load of the first node long enough to complete the transfer of the data block from the first node.

9. The medium of claim 7, further comprising instructions executable by the processing resource to cause the computing device to determine whether the backup power supply can support a load of the second node long enough to complete the transfer of the data block from the first node.

10. The medium of claim 7, further comprising instructions executable by the processing resource to partition a plurality of data blocks received from a plurality of nodes, the plurality of nodes including the first node, into independent non-volatile memory locations of the second node.

11. A method for data backup, comprising:
monitoring a plurality of nodes and a corresponding backup power supply;
initiating a transfer, utilizing the backup power supply, of data from at least a first node of the plurality of nodes to a non-volatile memory location on a second node of the plurality of nodes in response to an interruption of a primary power supply of the plurality of nodes;
shutting down each node of the plurality of nodes upon completing the transfer of its respective data;
restoring the data to its originating node of the plurality of nodes upon restoration of the corresponding backup power supply.

12. The method of claim 11, further including transferring the data from the at least first node to the non-volatile memory location on the second node, wherein the at least first node is a server node in a server chassis and the second node is a separate server node in the chassis.

13. The method of claim 11, further including transferring the data from the at least first node to the non-volatile memory location on the second node, wherein the at least first node is a server on a server rack and the second node is a separate server on the server rack.

14. The method of claim 11, further including transferring the data from the at least first node to the non-volatile memory location on the second node, wherein the at least first node is a server rack and the second node is a separate server rack.

15. The method of claim 11, wherein initiating the transfer, utilizing the backup power supply, includes initiating the transfer utilizing a plurality of distributed backup power supplies, each of the plurality of distributed backup power supplies powering a respective group of nodes.
